(19) United States
(12) Patent Application Publication
(10) Pub. No.: US 2004/0219302 A1
(43) Pub. Date: Nov. 4, 2004

(54) Selectively formed lenticular images

(76) Inventors: Donald R. Krause, Lomira, WI (US); Roger J. Heathcote, Oconomowoc, WI (US)

Correspondence Address: WHYTE HIRSCHBOECK DUDEK S C, 555 EAST WELLS STREET, SUITE 1900, MILWAUKEE, WI, 53202, US

(21) Appl. No.: 10/824,003

(22) Filed: Apr. 14, 2004

Related U.S. Application Data
(60) Provisional application No. 60/462,821, filed on Apr. 14, 2003.

(51) Int. Cl. B05D 3/06; B05C 11/02

(52) U.S. Cl. 427/496; 427/256; 427/558; 427/372.2; 156/230; 118/110; 118/100

(57) ABSTRACT

Disclosed herein is a method of creating a selectively formed lenticular image. The method comprises: providing a substrate having a printed interlaced image portion thereon; providing a coating applicator having a selectively-located coating transfer area that substantially conforms to the interlaced image portion on the substrate; applying to the interlaced image portion on the substrate, using the selectively-located coating transfer area, a coating layer that conforms to the interlaced image portion to form a coated interlaced image; curing the coated interlaced image to create a cured coated interlaced image; and forming a lenticular pattern in the cured coated interlaced image to create a selectively formed lenticular image. Adjusting the selectively formed lenticular images occurs by adjusting the selectively located transfer areas on the coating applicator. Also disclosed is a system for making a selectively formed lenticular image. The invention can include multiple applications, via one or more coating applicators, of coating material (e.g., lenticular plastic material) to create the selectively-placed lenticular image. The invention further includes substrates having multiple printed interlaced image portions resulting in a plurality of selectively placed lenticular images on the substrate. The invention allows for end products having defined lenticular image portions, multiple lenticular image portions, and variably placed lenticular effects. In this manner, additional applications for lenticular materials, combining lenticular images and other printing on the same page, are possible and commercially feasible. The invention is particularly useful when it is desired to have less than the full printed page or package dedicated to lenticular effects, with one or more image portions.

### CROSS-REFERENCE TO RELATED APPLICATIONS

This application claims the benefit of U.S. Provisional Application Serial No. 60/462,821 filed on Apr. 14, 2003, the teachings and disclosures of which are incorporated herein by reference.

### FIELD OF THE INVENTION

This invention relates generally to creating lenticular images and more specifically to creating selectively formed lenticular images.

### BACKGROUND OF THE INVENTION

Lenticular lenses take the form of a transparent plastic sheet or web, and the sheet typically includes an array of identical curved or ribbed surfaces that are formed (e.g., cast, coated, embossed, extruded, or co-extruded) on the front surface of the plastic sheet. The back surface of the lens is typically flat. Each lenticule or individual lens is typically a section of a long cylinder that focuses on, and extends over, substantially the full length of an underlying image. Other lens shapes or profiles are possible (for instance, pyramidal, trapezoidal, parabolic, and the like). The lenticular lens is generally created and/or selected to accommodate both the underlying image and the distance from which the image will ordinarily be viewed. Lenticular lenses and their technology are well-known and commercially available. Lenticular lens technology is described in greater detail in U.S. Pat. No. 5,113,213 and 5,266,995, the disclosures of which are incorporated herein by reference.

A lenticular image comprises a lenticular lens and an underlying precursor interlaced image. The preparation of interlaced images is well known in the art. An interlaced image is a composite of two or more component images that are themselves preferably of photographic quality. The component images are selected based upon the desired features of the lenticular or final image. The component images are then arranged, segmented, interlaced and mapped to create the interlaced image so that the image corresponds to the lenticular lens in a convenient manner, e.g., such as via the teachings of U.S. Pat. Nos. 5,488,451, 5,617,178, 5,847,808 and 5,896,230, the disclosures of which are incorporated herein by reference. The lenticular lens can include high definition lenses, for example, as taught in U.S. Pat. No. 6,424,467, which is incorporated herein by reference.

Interlaced images can be printed directly to the flat back surface of the lenticular sheet or film, e.g., as taught in U.S. Pat. No. 5,457,515, the disclosure of which is incorporated herein by reference.

In the printing industry, it is oftentimes desired to be able to integrate visual effects to printed products. In many cases, such effects such as holograms, 3-dimensional depth, motion and color are incorporated through the use of lenticular lens technology into printed magazines, advertisements, promotional materials, postcards, trading cards, publications, catalogs, books, labels, point-of-purchase displays, rigid and flexible package, and other printed products. In some cases, however, it is not desired to have the lenticular effects present on the entirety of the page or visible surface of the product of interest. Alternatively, it may be desired to have more than one lenticular effect on a page, albeit in different locations on the page.

In the past, it has been necessary to produce an interlaced image on the entirety of the page or sheet in order to create lenticular effects on any portion of the page. Because of this, it was difficult to incorporate non-lenticular portions of a page, such as non-interlaced images, text, pictures, and blank and non-printed areas with portions containing lenticular lens material. Additionally, the printing of an entire page or region of lenticular material regardless of the amount of space and placement of the lenticular images unnecessarily increases the cost of the printing process. In order to have a partial image on a page, piece, or other product, a lenticular piece would have to be manufactured separately and then subsequently affixed to the product. The resultant lenticular product would therefore require a separate step (i.e., the affixing) in addition to printing of or on the product, thus incurring additional time and cost.

Methods have been developed in which the end result is a localized lenticular image created on a web or sheet of substrate material, such as paper. For example, U.S. Pat. No. 5,330,799 to Sandor et al, teaches an inverse lenticular relief pattern that is used on an outer surface of a cylinder onto which a polymer layer is cured as it flows onto the relief pattern to create a lenticular lens. The lenticular lens is then subsequently transferred to a substrate having a printed area. In addition, U.S. Pat. No. 5,457,515 to Quadracci and Wicket teaches using an engraved plate to transfer a coating to a substrate, again having printed area. The coating is preformed by the plate prior to transfer. Therefore, in both of these instances, what is being transferred to the substrate having the printed area is in effect the transfer of the final lenticular lens.

Significantly, however, the prior methods fail to produce a localized lenticular image positioned in a predetermined location on a substrate in which a coating is transferred prior to forming a lenticular pattern in the coating. In other words, the prior art fails to teach selectively placing a lens material (and/or any associated coatings) on a substrate (so as to overlay the printed image on the substrate to make the lenticular image) prior to forming any lenticules (i.e., a lenticular pattern) in the lens or coating material.

Lenticular pattern forming devices (e.g., an embossing cylinder) represent a significant cost in the manufacture of lenticular lenses. To the extent that one device can be used for more than one print jobs, costs can be reduced significantly. In the above-identified prior methods, a cylinder would have to be manufactured with lenticular relief engraving in precise locations, and aligned and registered to the printed interlaced image. In other words, for a given lenticular image, a re-positioning of the interlaced image (or a different positioning from one print job to the next) would require a new or different lenticular pattern forming device.

Therefore, it would be desirable to be able to provide a method for selectively forming a localized lenticular image on a substrate with a printed area such that the lenticular lens is not created prior to transferring the lens material to the substrate, and such that, for a given lenticular lens resolution (lines per inch), the same lenticular pattern forming device could be used, regardless of the particular desired position of the localized lenticular images.

### BRIEF SUMMARY OF THE INVENTION

Disclosed herein is a method of creating a selectively-formed lenticular image. The method comprises: providing a substrate having a printed interlaced image portion thereon;

providing a coating applicator having a selectively-located coating transfer area that substantially conforms to the interlaced image portion on the substrate; applying to the interlaced image portion on the substrate, using the selectively-located coating transfer area, a coating layer that substantially conforms to the interlaced image portion to form a coated interlaced image; curing the coated interlaced image to a lenticular pattern forming curing level to create a cured coated interlaced image; and forming a lenticular pattern in the cured coated interlaced image to create a selectively formed lenticular image.

In another embodiment, disclosed herein is system for making a selectively-formed lenticular image. The system comprises: means for applying, to an interlaced image portion printed on a substrate, a coating layer that conforms to the interlaced image portion to form a coated interlaced image, the means comprising a selectively-located coating transfer area that substantially conforms to the interlaced image portion on the substrate; means for curing the coated interlaced image to a lenticular pattern forming curing level to create a cured coated interlaced image; and means for forming a lenticular pattern in the cured coated interlaced image to create a selectively formed lenticular image.

Other embodiments, aspects and advantages will become apparent in view of the teachings that follow, including the drawings.

### BRIEF DESCRIPTION OF THE DRAWINGS

The drawings illustrate the best mode presently contemplated for carrying out the invention.

In the drawings:

FIG. 1 is a schematic illustration of a procedure for selectively forming a lenticular image according to one aspect of the present invention;

FIG. 2 is a flow-chart of one embodiment of the present invention;

FIG. 3a is a schematic illustration of lithographic coating material transfer from a coating source unit to a coating applicator having a selectively-located coating transfer area according to one aspect of the present invention;

FIG. 3b is a schematic illustration of flexographic coating material transfer from a coating source unit to a coating applicator having a selectively-located coating transfer area according to one aspect of the present invention;

FIG. 3c is a schematic illustration of electrostatic coating material transfer from a coating source unit to a coating applicator having a selectively-located coating transfer area according to one aspect of the present invention;

FIG. 3d is a schematic illustration of gravure coating material transfer from a coating source unit to a coating applicator having a selectively-located coating transfer area according to one aspect of the present invention;

FIG. 4a is a partial schematic cross-sectional view showing lithographic coating material transfer from the coating applicator to a substrate using the coating applicator of FIG. 3a;

FIG. 4b is a partial schematic cross-sectional view showing flexographic coating material transfer from the coating applicator to a substrate using the coating applicator of FIG. 3b;

FIG. 4c is a partial schematic cross-sectional view showing electrostatic coating material transfer from the coating applicator to a substrate using the coating applicator of FIG. 3c;

FIG. 4d is a partial schematic cross-sectional view showing gravure coating material transfer from the coating applicator to a substrate using the coating applicator of FIG. 3d;

FIG. 5 shows a partial schematic view of a cured coated interlaced image formed in accordance with the method of FIG. 2;

FIG. 6a is front view of a lenticular pattern forming operation in accordance with the present invention;

FIG. 6b is an enlarged portion of FIG. 6a;

FIG. 7 shows a partial schematic cross-sectional view of a selectively formed lenticular image formed from the cured coated interlaced image of FIG. 5;

FIG. 8 is a flow-chart of another embodiment of the present invention;

FIGS. 9 shows a partial schematic view of an intermediate cured coated interlaced image formed in accordance with the method of FIG. 8;

FIG. 10 shows a partial schematic view of a cured coated interlaced image formed in accordance with the method of FIG. 8;

FIG. 11 is a partial schematic cross-sectional view of a selectively formed lenticular image formed from the cured coated interlaced image of FIG. 10;

FIG. 12 is a schematic illustration of an exemplary end-use product 200 incorporating selectively located lenticular images according to one aspect of the present invention; and

FIG. 13 is a perspective view of another embodiment of a lenticular pattern-forming device;

FIG. 14 is a schematic illustration of another method for selectively forming a lenticular image according to another aspect of the present invention;

FIGS. 15a-b are enlarged schematic illustrations of a lenticular pattern forming operation; and

FIG. 16 is a schematic illustration of another method for selectively forming a lenticular image according to another aspect of the present invention.

### DETAILED DESCRIPTION OF THE INVENTION

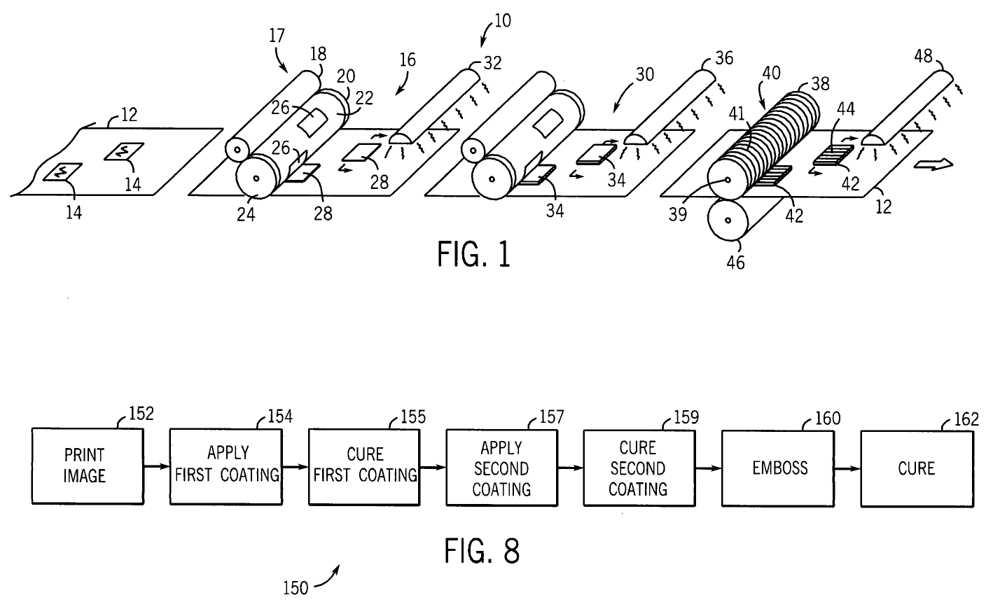

Referring to FIG. 1, a schematic illustration of a process for selectively forming a lenticular image according to one aspect of the present invention is illustrated. The selective lenticular image forming system is identified generally by the numeral 10. System 10 receives substrate 12 having printed interlaced image portions 14 thereon. There can be as many image portions 14 as are practical in any suitable arrangement, and image portions 14 can be of any size, shape or configuration, covering from a small fraction to the entirety of substrate 12, or any portion thereof. Substrate 12 is shown in a sheet configuration, to be sheet fed through system 10, but substrate 12 may also be part of a web roll and the web fed into system 10 in a known manner. Substrate 12 is commonly paper, but other substrates such as plastic, metal, synthetic paper, glass or wood may be used. In general, system 10 can be used both where the initial printing occurs as part of the process (on-site) or where previously printed materials requiring selectively formed lenticular effects are used as inputs to system 10. Image portions 14 are those image portions which, after application of the appropriate lenticular lens, will produce a lenticular effect (i.e. a lenticular image) as viewed through the appropriate lenticular lens. Although not specifically shown, it is contemplated that other images may be part of substrate 12, and such images may be non-lenticular graphics, printed text, bar codes, digital photos or any other suitable image. Substrate 12 is fed, whether in the form of a sheet or web, into a first coating and curing operation 16. In operation 16, a coating applicator 17 includes a coating unit 18 and plate roller 20. Coating unit 18 is shown generally as a cylinder (e.g., a metering cylinder). Coating unit 18 supplies a “coating”, or “varnish” to plate roller 20. By way of example, the coating applicator can be of the Analox or Rotary Screen types, among others.

As used herein, “coating”, “varnish” and “lenticular coating” are used to describe the material that is layered over the interlaced image(s) on the substrate. The coating material must be transparent, and preferably colorless, when cured. The cured coating must also be hard and flexible enough to withstand subsequent processing of the graphic material and eventual use. Furthermore, the coating must have, when a liquid, sufficient adherence to the substrate to which it is applied as well as appropriate viscosity and surface tension to allow the coating to either spread or not spread as desired in the particular coating operation. Another characteristic of the coating is to quickly cure in a sequential manner such that the coating is partially cured enough to accept and maintain the lens shape followed by full curing before subsequent handling. Sequential curing operations are used in other arts, see, e.g., U.S. Pat. No. 6,551,683, incorporated herein by reference.

In one embodiment, the coating that is used is a liquid polymer material or a liquid resin material, with the coating being “liquid” in that the material of which it is comprised is in liquid (e.g., molten) form when it is applied by the coating applicator. The coating can be layered, cured and formed as described herein, so as to create—in conjunction with the underlying image(s), a commercially desirable optical or visual multidimensional effect to a viewer viewing the final image through the coating at the appropriate viewing distance. The coating can potentially include a single material or including a plurality or combination of materials. Possible materials include, but are not limited to, thermoplastics, such as: polyester, vinyl, polycarbonate, polyvinyl chloride (“PVC”), polyethylene terephthalate glycol (“PETG”), amorphous polyethylene terephthalate (“APET”), polyethylene terephthalate (“PET”), polyphenylene oxides, polyamides or nylons, polystyrenes or other suitable materials. In one embodiment, the varnish can typically include an oil or a resin, in addition to a solvent. Reactive resins, such as acrylic and methacrylic resins, epoxies, polyester resins, urethane, shellac are also preferred for this invention.

Epoxy materials are thermosetting polymers meaning that they crosslink (“cure”) when heated. Polyimide materials are usually applied as a polyamic acid precursor in liquid form. During a high temperature cure step (e.g., 150.degree. C. for 30 minutes and 300.degree. C. for 60 minutes) the polyamic acid undergoes a chemical change (imidization) that causes it to become a solid polyimide resin.

The liquid coating may be either or both photocurable and thermocurable. As such, the liquid coating may additionally comprise curing agents such as photoinitiators and thermoinitiators. Suitable photoinitiators are well-known in the art and include phosphine oxide compounds and perfluorinated diphenyl titanocene compounds. Suitable thermoinitiators are typically free-radical initiators including peroxides, such as butyl peroctoates and dicumyl peroxide, and azo compounds. When the coating is exposed to ultraviolet light electron beam or heat (e.g., IR radiation) the photoinitiators are activated and react with the liquid coating to form a skin of hardened coating.

Still referring to FIG. 1, plate roller 20 includes a plate 22 that is formed around or otherwise secured to cylinder 24. Coating applicator 17, and in this instance plate roller 20, includes selectively-located coating transfer areas 26 that correspond to the size and shape of interlaced image portions 14. In a preferred embodiment, plate 22 is removable and may be substituted with other plates having differing arrangements of selectively-located coating transfer areas. With such an arrangement, variations from one run to another, or from one project to another, may be accomplished simply by producing a new plate (as opposed to a new cylinder) having selectively-located coating transfer areas that conform to the new or changed interlaced image portion(s) where lenticular effects are desired. As a practical matter, the coating material will typically be applied in a liquid form.

Plate 22 includes selectively-located coating transfer areas 26 that can be used in the following coating transfer processes: lithographic (or “offset lithographic”), flexographic or letterpress (i.e., including a portion that is physically raised), electrostatic (i.e., including a portion that is charged or uncharged), and gravure (i.e., including a portion that is recessed, debossed, welled or “pocketed”), so as to effect coating transfer between coating applicator 17 substrate 12.

The word “conform” is used herein to denote a relationship between the selectively located coating transfer areas, the interlaced image portion(s) on the substrate and the coating material itself. More specifically, the selectively-located coating transfer area(s) “conforms” to the interlaced image portion(s) in that the area matches, mimics, or coincides with the size and shape of the interlaced image portion(s). Moreover, the selectively-located coating transfer area is used to transfer, directly or indirectly (e.g., via an offset lithographic process), the coating material to cover or substantially cover the interlaced image portion(s). Accordingly, the coating layer itself ultimately conforms, or substantially conforms, to the interlaced image portion(s) in that the material matches, mimics, or otherwise coincides with the size and shape of the interlaced image portion(s).

Coated interlaced image 28 is then cured by curing unit 32. Curing occurs until the coating achieves curing level, which may be predetermined. The curing level can be dependent on a variety of variables, but in a preferred embodiment corresponds to a stiffness or tension of the coating such that it is suitable for either: a) accepting and maintaining shaping, profiling and/or patterning of a lenticular pattern by a pattern forming device; or b) accepting another or a subsequent coating layer, as well as, bonding of that subsequent layer to the previous layer. The former can be termed a “lenticular pattern forming curing level” and the latter can be termed a “coating layer application curing level”. The curing level is determined by a number of factors, including but not limited to: coating material type (described below), material temperature, and operating environment temperature and humidity, and the pressure applied by the pattern forming device, or alternatively, the subsequent layer. These factors are taken into account to set or determine an initial, or subsequent curing levels.

Curing may take any acceptable form, and in preferred embodiments includes ultraviolet (UV) and electron-beam (EB) curing techniques. In one embodiment, a single coating and curing operation 16 occurs. In other embodiments of the present invention, additional coating and curing operations, shown as second coating and curing operation 30, may be used in order to build upon the coating present on coated (and initially cured ) interlaced image 28 to create a cured coated interlaced image 34 having the desired coating depth. Cured coated interlaced image 34 is then cured by curing unit 36 (finally cured if there are no more coating and curing operations and the required depth of coating is achieved). Again, if multiple coating and curing operations are used, an “intermediate” coated interlaced image is created.

More coating and curing operations may be required and are contemplated. Operations 16 and 30 may be performed by the same units, by feeding the same sheets multiple times into the same apparatus, or by separate units positioned, for example, in-line, where one operation receives the output of the previous operation.

The thickness of the coating on coated interlaced image 28 will vary according to the needs of the particular use of substrate 12, and more coating and curing operations may be used in an effort to build up the desired level of coating on printed interlaced image portion 14. The desired layering will be dependent upon desired lenticular characteristics such as desired depth, pitch, gauge thickness, focal length, lens definition, and other similar factors that vary according to the application and desired result. Exemplary lens pitches and corresponding gauge thickness include: 100 lines or lenticules per inch (also referred to as “lpi” or “lenticule count”), for 14 mils, 200 lpi and 6 mils, 300 lpi and 5 mils, and.

Once the desired thickness of lenticular material is built up and cured to a predetermined level of cure, resulting in cured coated interlaced image 34, image 34 is fed through a lenticular pattern forming device 38. In a preferred embodiment lenticular pattern forming device 38 is an engraved cylinder having pattern 40. Selectively formed lenticular image 42 includes a plurality of lenticules (i.e., a lenticular pattern) 44, which are created using cylinder pattern 40. In other words, pattern 40 is selected to impart the desired resolution, or lines per inch (LPI), onto cured coated interlaced image 34. Pattern 40 includes a plurality of grooves 41 that typically run either parallel to, or concentric with, a central longitudinal axis 39 of lenticular pattern forming device 38. By rotating lenticular pattern forming device 38, pattern 40 is transferred to cured coated interlaced image 34 to form a selectively formed lenticular image 42. Selectively formed lenticular image 42 will have lenticules 44. Lenticular pattern forming device 38 is positioned with respect to pressure roller 46 and substrate 12 such that pattern 40 will press into cured coated interlaced image(s) 34 Forming occurs exclusively on cured coated interlaced image(s) 34 to create selectively formed lenticular image(s) 42. In other words, pattern 40 is not formed into any other part of substrate 12. Additionally, the depth of pattern 40 to be formed into selectively formed lenticular image 42 can be set to produce superior lenticular results. One preferred depth of pattern 40 is to form a lenticular pattern about one-third of the gauge thickness of the lenticular lens (which includes one or more coating layers). Regardless of the depth, a substantially uniform pattern is formed into selectively formed lenticular image 42. Preferably, the forming is accomplished by embossing cured coated interlaced image(s) 34 to create selectively formed lenticular image(s) 42. The result is that the embossing occurs in the same areas of substrate 12 onto which printed lenticular image portions were originally printed.

Following embossing or other type of forming of the lenticular pattern 40 into selectively formed lenticular image 42, additional curing operation 48 may occur if necessary to properly form (e.g., solidify or harden) the final lenticular image and provide the necessary finishing of the lenticular lens, as appropriate.

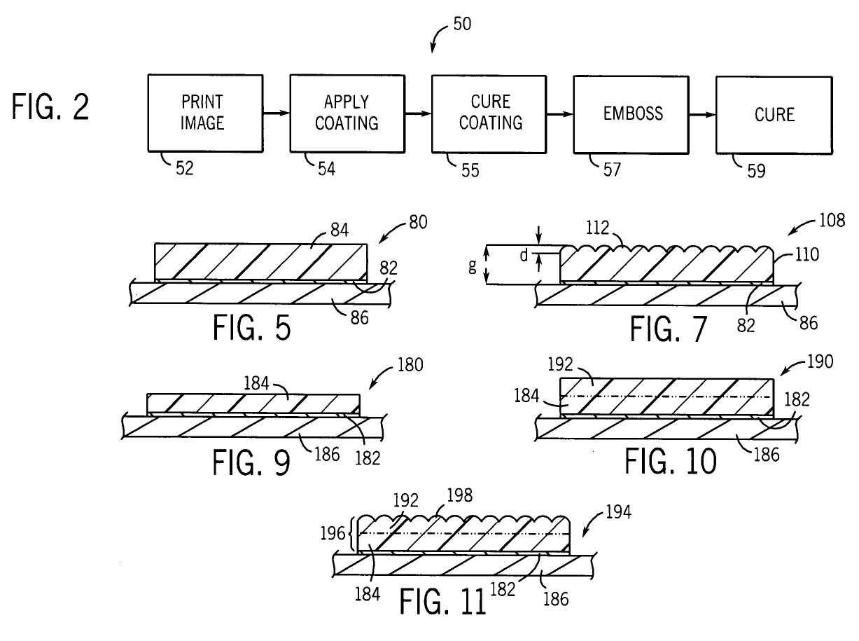

FIG. 2 illustrates a flow-chart of one embodiment of a procedure 50 for producing the selectively formed lenticular image 42 of FIG. 1. Procedure 50 illustrates a single coat-cure operation (final curing notwithstanding), but it shall be understood that the invention can include more or fewer coat-cure operations as needed. Printing 52 of the image portion is a necessary pre-condition, and includes selection of the particularized locations for the interlaced images, as well as determining their number, size and shape, and whether there will be any non-lenticular printing, text or graphics. The interlaced image can include component colors, for example, cyan, magenta, yellow and black (“CMYK”), red, green and blue (“RGB”), or an “invisible” ink viewable only under specialized lighting conditions, such as UV lighting. The interlaced image can be printed by a variety of techniques, including lithographic, flexographic, gravure, roto-gravure, letter-press, laser, inkjet, screen, digital, sheet- fed and web type printing, among others. Other information can be printed on the substrate, for example, non-interlaced image(s), text, graphics, pictures, and the substrate may also include blank or “non-printed” regions as well.

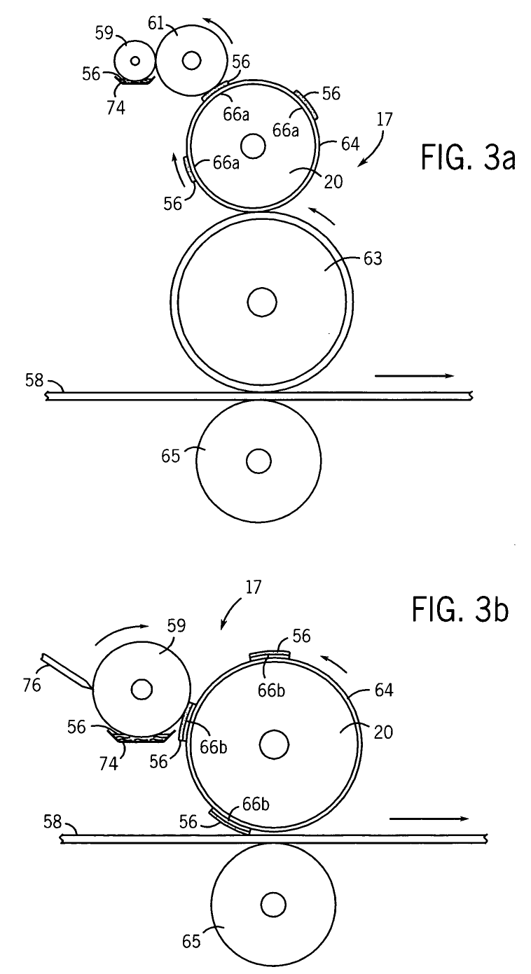

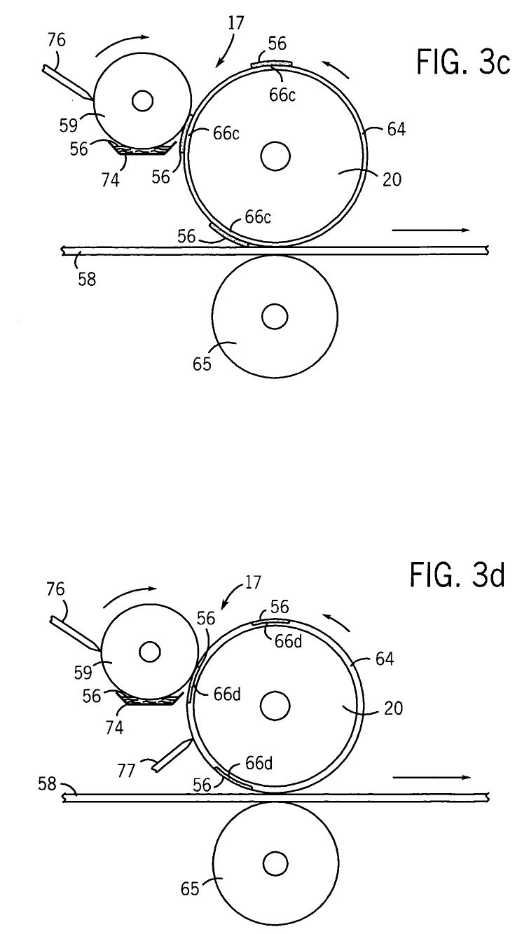

Next, a first layer of the coating material is applied 54. More specifically, as shown in FIGS. 3a-3d, coating material 56 can be applied over the pre-selected interlaced image portions of substrate 58 (i.e., portions where at least one interlaced image is printed on the substrate). The application of the coating can be accomplished through the use of a coating applicator 17. Coating applicator 17 includes a plate cylinder 62 having a plate 64, the plate (e.g., a lithographic, flexographic, electrostatic or rotogravure plate) having selectively located coating transfer areas 66a-d.

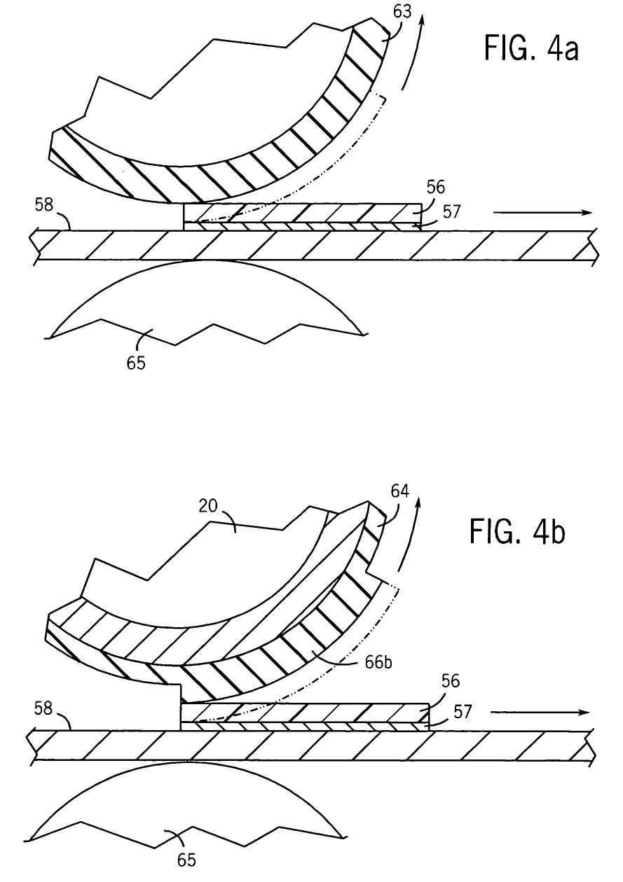

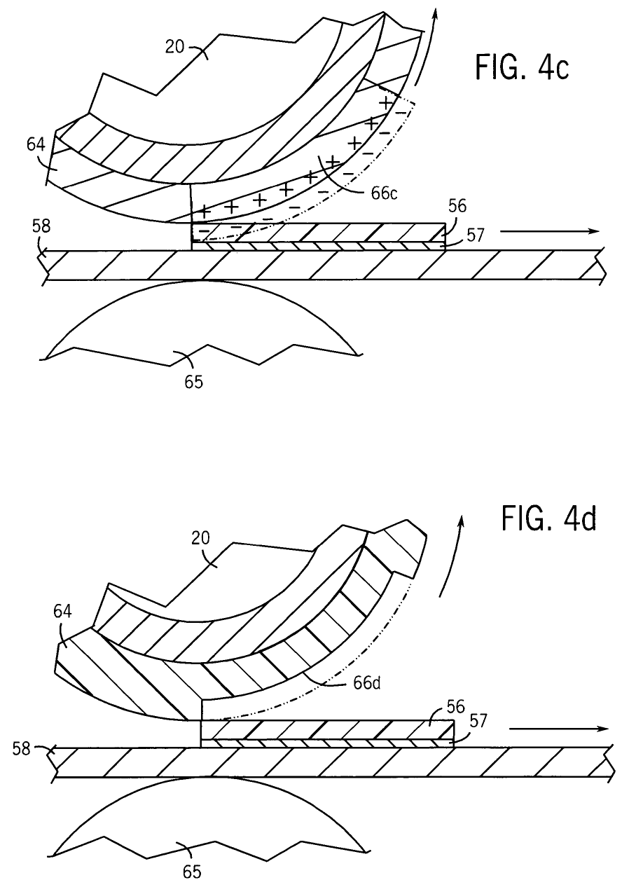

As shown in FIGS. 3a and 4a, in one embodiment, coating material 56 (e.g., plastic, varnish, or other lenticular material) is lithographically transferred to substrate 58 via selectively-located coating transfer areas 66a so as to accomplish the transfer of the coating only to the interlaced image portions 57 on the substrate 58. Lithographic transfer, whether via offset lithographic processes or otherwise, can include a chemical repulsion or repelling between the coating material and the coating transfer areas(s). In this embodiment, coating applicator includes metering roller 59, form roller 61, plate roller 20, and blanket roller 63. Metering roller 59 rotates, and picks up coating material 56 (which is at this point typically in a liquid form) from reservoir 74 and transfers the material to form roller 61. Form roller then lithographically transfers coating material 56 to plate roller 20, and more specifically, the material is transferred to selectively located transfer areas 66a. Finally, the coating material 56 is transferred to interlaced image portions 57 on substrate 58, here indirectly using blanket cylinder or roller 63. An impression roller 65 can be used to create a necessary nip or pressure for proper transfer of coating material 56 to substrate 58. In this embodiment, the selectively-located coating transfer areas 66a can be flush with the surface of plate 64. The rollers shown can rotate, and the substrate can be moved, as indicated by the arrows shown, to accomplish the coating material transfer.

Turning to FIGS. 3b and 4b, in another embodiment of the present invention, coating material 56 is flexographically transferred to substrate 58, here via selectively-located coating transfer areas 66b so as to accomplish the transfer of the coating only to the interlaced image portions 57 on the substrate 58. In this embodiment, selectively-located coating transfer areas 66b are created to be raised portions which physically contact coating material 56 so as to accomplish the transfer of the coating only to the interlaced image portions 57 on the substrate 58. In operation, coating applicator 17 includes plate roller 20 which rotates relative to a metering roller 59. Metering roller 59 picks up coating material 56, which is again shown to be located in a collection area or trough 74. Coating material 56 is picked up by roller 59, transferred via physical contact to selectively-located coating transfer areas 66b on plate 64 of plate roller 20, and subsequently transferred to interlaced image portions 57 on substrate 58. A device 76 (e.g., doctor or doctoring blade) can be included as desired to ensure that an even and smooth coating layer having a desired thickness (whether uniform or varied) is moved from the coating applicator to the substrate, and more specifically, in this embodiment from the metering roller to the plate roller. An impression roller 65 can be used to create a necessary nip or pressure for proper transfer of coating material 56 to substrate 58. The rollers shown can rotate, and the substrate can be moved, as indicated by the arrows shown, to accomplish the coating material transfer. In one embodiment, coating applicator 60 can includes slot or slot-type die, which can be used in the manufacture of a banner or continuous panel or ribbon.

Turning to FIGS. 3c and 4c, in another embodiment of the present invention, coating material 56 is electrostatically transferred to substrate 58, here via selectively-located coating transfer areas 66c so as to accomplish the transfer of the coating only to the interlaced image portions 57 on the substrate 58. In this embodiment, selectively-located coating transfer areas 66c are charged (e.g., with a positive charge as shown) so as to electrostatically adhere with or otherwise attract coating material 56 which is oppositely charged. In operation, coating applicator 17 again includes plate roller 20 which rotates relative to a metering roller 59. Metering roller 59 picks up coating material 56, which is again shown to be located in a collection area or trough 74. Coating material 56 is picked up by roller 59, transferred electrostatically to selectively-located coating transfer areas 66c on plate 64 of plate roller 20, and subsequently transferred to interlaced image portions 57 on substrate 58. A device 76 (e.g., doctor or doctoring blade) can again be included as desired to ensure that an even and smooth coating layer having a desired thickness (whether uniform or varied) is moved from the coating applicator to the substrate, and more specifically, in this embodiment from the metering roller to the plate roller. Impression roller 65 is also used to create a necessary nip or pressure for proper transfer of coating material 56 to substrate 58, that is, a sufficient pressure to overcome the electrostatic (also referred to as “electrical” or “charged”) adherence described above. Transfer can also be accomplished with electrical or charged adherence (alone or in combination with the pressure from the nip) between the coating and the substrate bearing the interlaced image. The rollers shown can rotate, and the substrate can be moved, as indicated by the arrows shown, to accomplish the coating material transfer. In an alternative embodiment, the electrostatic transfer of the coating can be accomplished via an “offset” or “indirect” mechanical arrangement similar to that illustrated in FIGS. 3a and 4a.

In FIGS. 3d and 4d, another embodiment of the present invention, coating material 56 is transferred to substrate 58, here using a gravure or rotogravure arrangement, via selectively-located coating transfer areas 66d so as to accomplish the transfer of the coating only to the interlaced image portions 57 on the substrate 58. In this embodiment, selectively-located coating transfer areas 66d are recessed or welled for purposes of collecting coating material 56. In operation, coating applicator 17 again includes plate roller 20 which rotates relative to a metering roller 59. Metering roller 59 picks up coating material 56, which is again shown to be located in a collection area or trough 74. Coating material 56 is picked up by roller 59, transferred to selectively-located coating transfer areas 66d recessed in plate 64 of plate roller 20, and subsequently transferred to interlaced image portions 57 on substrate 58. A first device 76 (e.g., doctor or doctoring blade) can again be included as desired to ensure that an even and smooth coating layer having a desired thickness (whether uniform or varied) is moved from the coating applicator to the substrate, and more specifically, in this embodiment from the metering roller to the plate roller. A second device 77 (e.g., a doctor blade) can be used to level off coating material 56 in the recessed selectively located coating transfer areas 66d. Impression roller 65 is also used to create a necessary nip or pressure for proper transfer of coating material 56 to substrate 58. The rollers shown can rotate, and the substrate can be moved, as indicated by the arrows shown, to accomplish the coating material transfer.

It should be understood that FIGS. 3a-d and 4a-d are schematic in nature so as to facilitate understanding of the invention. Other rollers, mechanisms, and mechanical components (e.g., roller trains comprising a plurality of rollers) can be utilized as needed and can be employed by those of skill in the respective art.

FIG. 5 illustrates a coated interlaced image 80, which results from the coating step 54, which has been shown and described above with respect to FIGS. 2, 3a-b, and 4a-b. A typical coated interlaced image 80 includes interlaced image portion 82 and coating material layer 84 selectively located over the interlaced image portion, with the image portion and coating layer on substrate 86. The method can include contacting the cured coated interlaced image with the lenticular pattern-forming device and controlling the temperature of the lenticular pattern forming device to facilitate release of the cured coated interlaced image from the lenticular pattern forming device.

Returning to FIG. 2, following the applying step, the coated interlaced image is cured 55. Following curing, as used herein, coated interlaced image 80 (FIG. 5) is considered a cured coated interlaced image. In preferred embodiments, the curing can be ultraviolet (UV) curing, electron-beam (EB) curing, or heat set curing techniques. Curing techniques are known and result in, for example, obtaining proper strength, elasticity, stiffness, hardness, among other things, of the material being cured. Generally, curing can take place until the material being cured attains a predetermined level of cure.

Next, following the curing step, the cured, coated interlaced image is formed 57 into a selectively-formed lenticular image. In a preferred embodiment of the present invention, the cured coated interlaced image is embossed 57 in a lenticular pattern-forming operation. A final curing 58 may be including following forming 57 as desired.

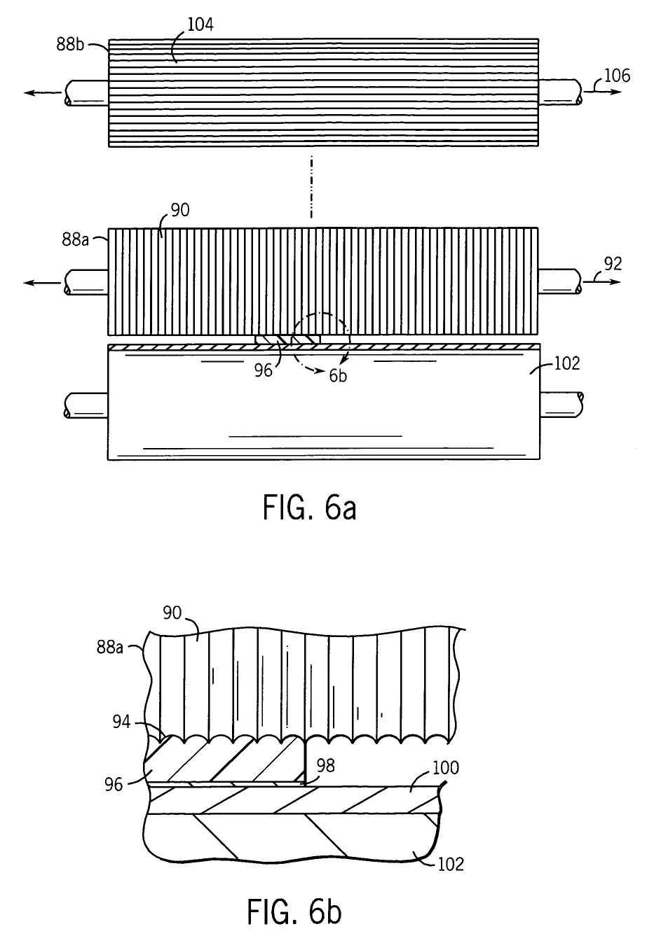

Referring to FIGS. 6a-b, a front view of a lenticular pattern forming operation, and an enlarged view of that operation, are shown in accordance with one aspect of the present invention. As shown, two embodiments 88a-b of a lenticular pattern forming device are shown. In the first embodiment 88a of the pattern-forming device, the device includes a plurality of grooves 90 that are aligned to be concentric with a central longitudinal axis 92 of the pattern forming device. The grooves 90 are used to form, preferably by embossing, a lenticular pattern 94 in coating layer 96, with the coating layer selectively located with respect to interlaced image portion 98 on substrate 100. Pressure roller 102 holds the coating layer and substrate having the interlaced image portion(s) in place as embossing occurs. In an alternative embodiment, pattern-forming device 88b includes a plurality of grooves 104 which are aligned to be parallel to the central longitudinal axis of the device 106. Preferably, the lenticular pattern-forming device has a groove pattern that covers substantially the entire device arcuate surface area. One pattern-forming device for use with the present invention is described in greater detail in U.S. patent application Ser. No. 10/340,075, which is incorporated herein by reference.

FIG. 7 shows a partial schematic cross-sectional view of a selectively formed lenticular image 108 formed from, preferably by embossing, the cured coated interlaced image 80 of FIG. .5. Selectively-formed lenticular image 108 includes interlaced image portion 82 and lenticular lens 10 having a plurality of lenticules 112 selectively located over the interlaced image portion, with the image portion and lenticular lens located on substrate 86. Lenticular lens 110 is designed to have a gauge thickness that permits proper viewing (i.e., imparts the proper illusion of multidimensionality and such that the image is at the proper focal length) to a viewer viewing the interlaced image portion through the lens at the desired view distance. Gauge thickness “G” of lens 110 correlates to the thickness of the lens as measured from the top of lenticules 112 to the bottom of the lens material (i.e., the flat back surface of the lens to which the interlaced image 82 is joined) as illustrated. In a preferred embodiment, the gauge thickness “G” of the lenticular lens is equal to its focal length. Lenticules 112 are formed to a forming depth “D” which is measured from the top of lenticules 112 to the point at which one lenticule ends and another begins as illustrated. In a preferred embodiment, a lens having a gauge thickness of less than 10 mils can be used. In another preferred embodiment, a desired forming depth is in a range from about five percent (5%) to about thirty percent (30%) of the gauge thickness. For example, for a lens having a gauge thickness G of about 6 mils, the forming depth D would be about 2.0 mils. In any event, one of the goals of the forming is to achieve a full reproduction of the pattern (i.e., the engraved pattern in the pattern forming device). In general, the gauge thickness G and forming depth D are selected base on a number of factors, including the interlaced image and the anticipated viewing distance of the viewer, so as to achieve optimum optical clarity and quality for the intended multidimensional effect(s).

A proper selectively formed lenticular image 108 minimizes image degradation. Image degradation can take a variety of forms, and these include, for example, blurring and/or ghosting of an image. Typically, a viewer will view the lenticular image from a desired or predetermined distance. To achieve the desired affect (i.e., motion and or depth), the viewer when viewing the lenticular image, will change the angle of observation of the image. This can be accomplished the viewer moving from one location to another, by moving the lenticular image itself (e.g., a hand-held image on a cup or trading card), or a combination of both. Again, the precursor image (which is joined to the lenticular lens to make the lenticular image) is a composite of two or more component images. As the angle of observation changes for a viewer, typically one or more of the component images is intended to be viewed. The remaining component images are not intended to be viewed at that angle of observation. “Ghosting” occurs when those image(s) that are not intended to be seen by a viewer are in fact seen.

FIG. 8 is a flow-chart of another embodiment of the present invention. In this embodiment, a plurality, and in particular two, cure-coat operations (also called “dual” cure-coat operations) are illustrated. Dual cure-coat operations are desirable in instances in which the application, use or end product requires a build-up of coating material to achieve a lenticular lens having a desired gauge thickness. Printing 152 of the interlaced image portion occurs, again as a necessary pre-condition to manufacturing the selectively formed lenticular image. Next, a first layer of the coating material is applied 154. The application of the coating can be accomplished in accordance with the process as set forth above with respect to FIG. 2.

FIG. 9 shows a partial schematic view of an intermediate coated interlaced image 180 formed in accordance with the method of FIG. 8. This intermediate image results from the coating step 154 (FIG. 8). A typical intermediate coated interlaced image 180 includes interlaced image portion 182 and coating material layer 184 selectively located over the interlaced image portion, with the image portion and coating layer on substrate 186.

Returning to FIG. 8, even if ever so briefly, following the applying step, the intermediate coating layer 184 is cured 155. Following curing, as used herein, intermediate coated interlaced image 180 (FIG. 9) is considered a cured intermediate coated interlaced image. Again, in preferred embodiments, the curing can be ultraviolet (UV) curing, electron-beam (EB) curing, or heat set curing techniques. A second layer of coating material is applied 157 in a similar fashion as the first coating layer, with the understanding that the second coating layer is applied to the first coating layer (as opposed to the interlaced image portion). Nonetheless, the second coating layer conforms to the interlaced image portion. Subsequently, curing of the second coating layer 159 can occur.

FIG. 10 shows a partial schematic view of a cured coated interlaced image 190 formed in accordance with the method of FIG. 8. Cured coated interlaced image 190, as shown, includes interlaced image portion 182 of substrate 186 with intermediate coating layer 184 and second, and in this instance final, coating layer 192 conforming to the interlaced image portion.

Turning to FIG. 8, following curing 159, cured coated interlaced image is formed 160, into a selectively-formed lenticular image. In a preferred embodiment of the present invention, the cured coated interlaced image is embossed in a lenticular pattern-forming operation (in a fashion similar to that of FIGS. 6a-b). A final curing 162 may be included following forming 160 as desired.

FIG. 11 is a partial schematic cross-sectional view of a selectively formed lenticular image 194 formed from the cured coated interlaced image 160 of FIG. 10. Lenticular image 194 includes interlaced image portion 182 on substrate 186, with lenticular lens 196 comprising coating layers 184 and 192, with a plurality of lenticules 198 formed in layer 192.

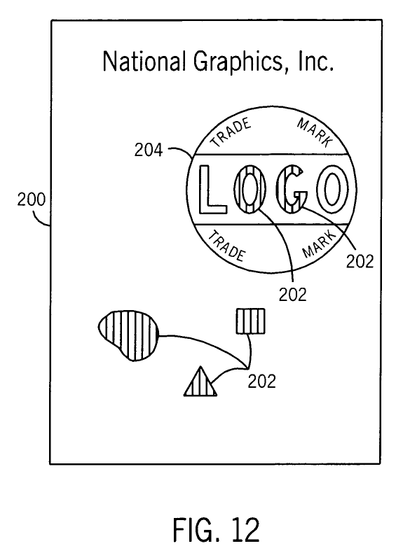

FIG. 12 is a schematic illustration of an exemplary end-use product 200 incorporating selectively formed lenticular image(s) 202 according to one aspect of the present invention. The selectively formed lenticular image as shown, constitute the entire or substantially the entire image, or alternatively, a portion(s) of a larger printed area 204. In other words, during product development, areas or portions of areas can be selected for placement of the selectively formed lenticular image(s). Suitable end-use products may include: printed (e.g., magazine, newspaper) pages, advertisement inserts, book covers, product packages, containers, labels, CD or DVD covers or “tip-ons”, cups sleeves, and point-of-purchase displays, among others. The end product, again, can be made or created using web or sheet format technologies.

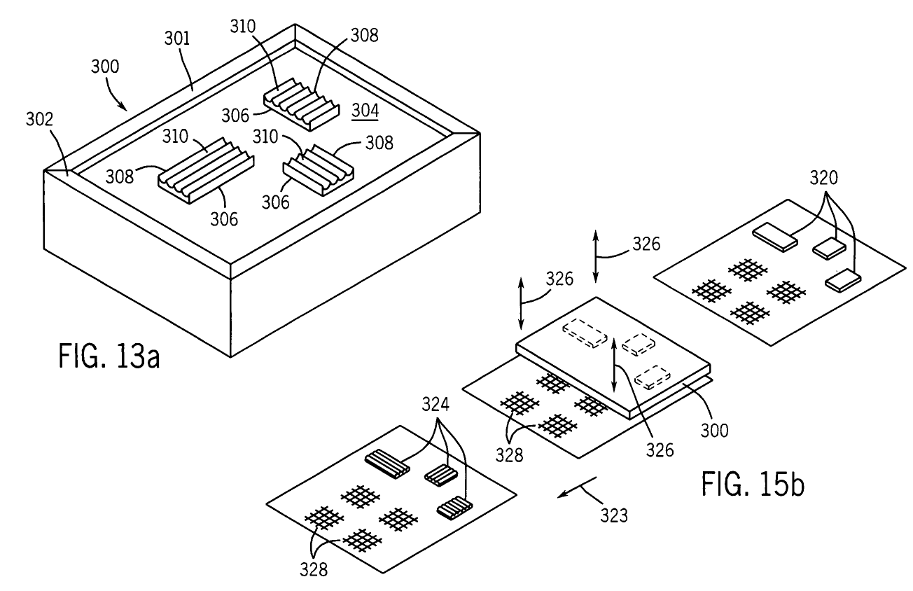

Referring to FIG. 13, a perspective view of another embodiment of a lenticular pattern-forming device 300 is shown, the device comprising a flat platen 301 (also called a chase or a mandrel) having a bottom face 302. For illustration purposes, the device 300 is oriented such that the bottom face 302 is visible and top face is hidden. The top face of the platen can be heated (e.g., via electrical or heating oil means) or cooled as necessary, in whole or in part (e.g., heated or heatable “zones” of the top platen surface). The flat platen bottom face 302 includes a recessed area 304 in which a plurality of lenticular selective pattern-forming dies 306 (in this case, three representative dies are illustrated) can be positioned for use. The recessed area could also be a flat area (not shown). Each die 306 includes a lenticular pattern-forming surface 308 (in this case for embossing) having a shape which includes a plurality of grooves 310, with each groove having a size and shape that corresponds (i.e., is the inverse of) to each individual lenticule of a lenticular lens to be created by the respective die 306. As illustrated, grooves 310 are parabolic in shape, although other shapes (e.g., elliptical, trapezoidal, triangular, saw-toothed, circular, semi-circular, etc.) are contemplated and within the scope of the present invention.

The size and shape of the platen 301 itself is generally designed to correspond to the size of the substrate or printed material. The depth of the recess 304 is selected based on the size and type of the material to be embossed or formed. Significantly, the selective pattern-forming dies 306 can be oriented in any direction as desired, and as shown, in a plurality of directions, to achieve a variety of multidimensional effects on a single printed page or substrate. The selection of the number and position of the selective pattern-forming dies 306 can be accomplished based on the number of lenticular images to be created, and as will be described in greater detail, are sized and positioned to conform to the selectively located interlaced images. The selective pattern-forming dies can be sized to create lenticular patterns of varying size and/or pitch such that lenticules of varying width and depth can be created. The selective pattern-forming dies 306 are positioned and received within the platen 301 using, by way of example, electromagnetic, permanent magnet, or mechanical (e.g., adjustable set screws) attachment means.

It should be noted that, in one embodiment, the die size can vary from the smallest size of lenticular effects desired to a single die that covers or fills substantially all of the recessed area can be used so as to accomplish lenticular pattern forming in a manner similar to that accomplished using the pattern-forming device described previously with respect to FIGS. 6a-b. Such an embodiment is shown in FIG. 13b. Stated another way, lenticular pattern-forming device 300 having the full recess area die 305 within platen 301 would look similar to unrolling a cylindrical lenticular pattern forming device. Also, it is contemplated that the platen size and one or more die size(s) may be varied in different combinations and ratios to achieve a commercially viable lenticular pattern-forming device.

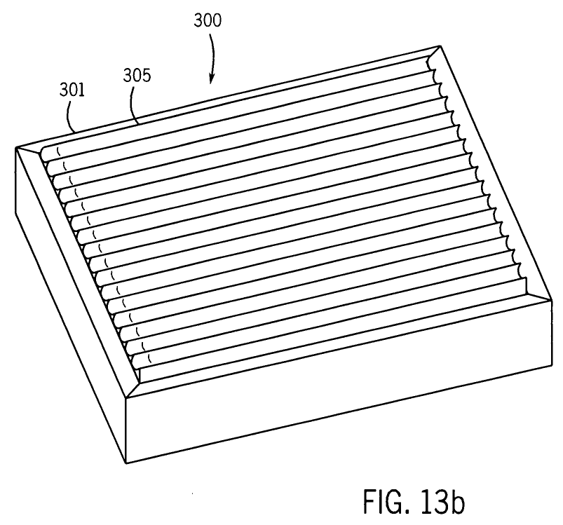

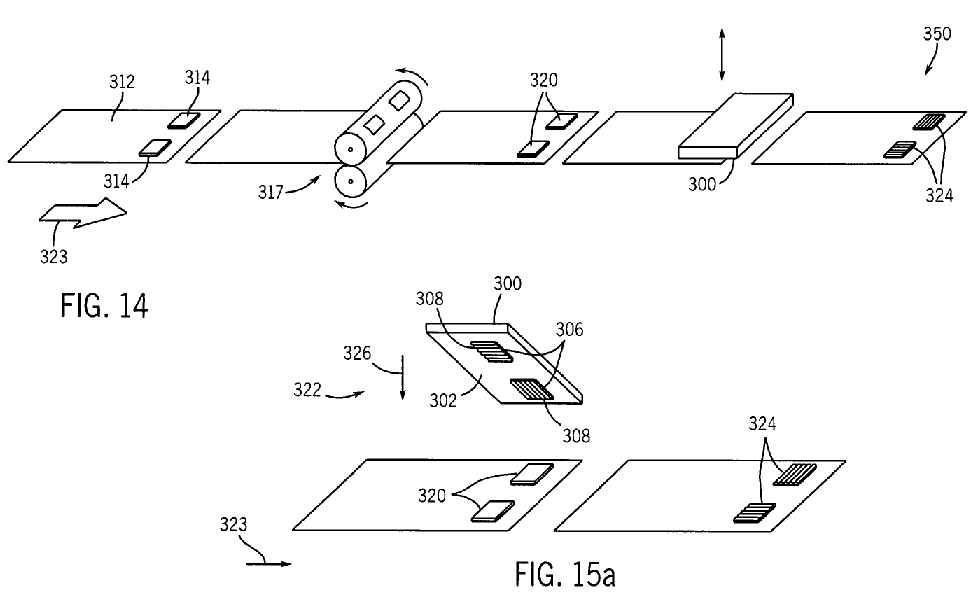

Referring to FIG. 14, a schematic illustration of another method for selectively forming a lenticular image according to another aspect of the present invention is shown. In general, the method follows those methods described previously with respect to FIGS. 1-12, where those elements are in common. It is noted that, for purposes of simplification and clarity here, curing operations (whether one or more) are not illustrated. The selective lenticular image forming system here is generally indicated by the numeral 350. System 350 receives a substrate 312 having printed interlaced image portions 314 thereon (see FIG. 1 and associated description relating to the substrate and the interlaced image portions). A coating applicator 317 is also shown to selectively apply coating material to the substrate 312, and more particularly, to the printed portions 314 on the substrate, in a manner as described previously with respect to FIGS. 1-12. Following a curing operation, cured coated interlaced image(s) 320 is created and the cured coated interlaced image(s) is then formed into selectively formed lenticular image(s) 324 using, as shown, a lenticular pattern-forming device 300.

FIGS. 15a-b are enlarged schematic illustrations of a lenticular pattern forming operation 322. Referring now to FIGS. 13 and 15a-b, the lenticular pattern-forming device 300 is maneuvered or manipulated to position the plurality of selective pattern-forming dies 306 located along the flat platen bottom face 302, and specifically the grooved die pattern-forming surfaces 308, in contact with the cured coated interlaced image(s) 320. The substrate 312 generally moves in a direction indicated by arrow 323. In this fashion, lenticular patterns are formed (again, as shown by stamping or embossing) in the coating layer(s) of the cured coated interlaced image(s) 320. Significantly, since the dies 306 conform to the precise location of the cured coated interlaced images 320, a plurality of selectively formed lenticular images 324 are formed. Also shown are printed, non-lenticular images or areas 328. The lenticular pattern-forming device 300 accomplishes the forming via a motion indicated by arrows 326. The pattern-forming device 300 can form the lenticular pattern at a pressure that is applied in an adjustable fashion. It is noted that, although not shown, additional post forming or embossing operations can take place as desired or required.

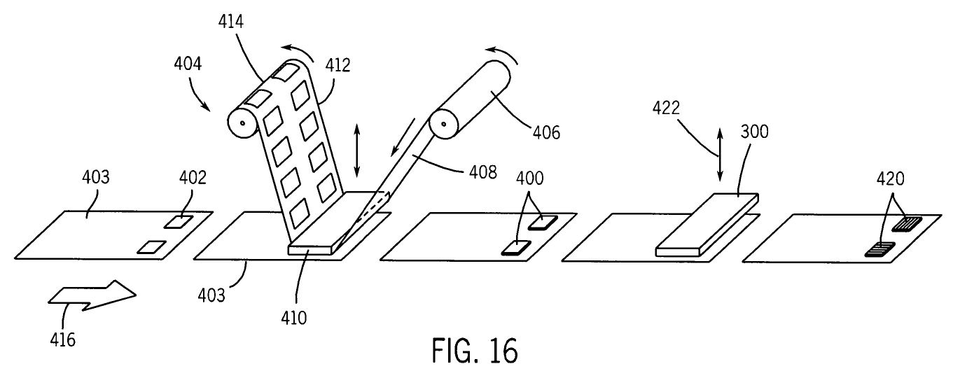

FIG. 16 is a schematic illustration of another method for selectively forming a lenticular image according to another aspect of the present invention. Here, to create a cured coated interlaced image 400, a coating is again selectively applied to preprinted interlaced image areas 402 on substrate 403. As shown, a coating applicator 404 includes a roll 406 of foil or membrane coating 408. The membrane is generally a pre-manufactured (as opposed to applied in a fashion previously described) material which is preferably substantially clear. One material for use in the present invention is gloss C010100, available from API Group, PLC, of the United Kingdom.

The coating is tranferable from a carrier roll or web 406 to the substrate 403 and specifically, to image areas 402 with heat (e.g. via heated or heatable zones as described above) and pressure via, as shown, platen or stamping unit 410. Stamping unit 410 mimics the unit 300 described above, however, unit 410 does not here include selective pattern-forming dies, but rather, includes dies that are flat or substantially flat (i.e., the dies do not include surfaces that correspond in inverse fashion to the lenticular pattern to be formed). Significantly, since the flat dies also conform to the pre-printed interlaced image or image areas 402, membrane portions are selectively transferred to the substrate to precisely overlay the printed image areas. The remaining membrane 412 is taken up as waste roll 414 as shown. The substrate having coated interlaced images proceeds in a direction indicated by arrow 416 to be cured with one or more curing operations as described previously. And the cured coated interlaced image 400 can then be formed into selectively located lenticular images 420 using lenticular pattern forming device 300 (described with reference to FIGS. 13a-b and 15a-b) via motion of device 300 as generally indicated by arrows 422. In one embodiment, this process can be referred to as a hot stamping selectively located lenticular image forming process using a foil or membrane.

The methods described above can be accomplished by a variety of physical means performing the functions of the above steps. For example, the invention can include a system for making a selectively-formed lenticular image comprising: means for applying, to an interlaced image portion printed on a substrate, a coating layer that conforms to the interlaced image portion to form a coated interlaced image, the means comprising a selectively-located coating transfer area that conforms to the interlaced image portion on the substrate; means for curing the coated interlaced image to create a cured coated interlaced image; and means for forming a lenticular pattern in the cured coated interlaced image to create a selectively formed lenticular image.

It may be desired for some applications to incorporate the ability to create a selectively formed lenticular image on both sides of a substrate (whether in sheet or web format). To that end, a perfecting or perfector press, which turns or rotates the substrate to accomplish this dual-sided lenticular product, can be used in conjunction with the present invention. In this manner, the transfer of one or more coating layers to selectively formed interlaced images disposed on both sides of a substrate can be accomplished.

Generally, methods have been described and outlined in a sequential fashion. Still, modification, rearrangement, combination, reordering, or the like, of the methods is contemplated and considered within the scope of the appending claims.

The present invention provides a system and method that allows for a lenticular pattern to be formed (e.g., embossed) in a coating independent of the location of the coating on the substrate over a printed interlaced image. Advantageously, the same pattern forming device (e.g., engraved embossing cylinder) can be used from one print job to the next (or with coated interlaced images that vary in their locations even within a print job). In other words, the forming by the lenticular pattern forming device is independent of a change in the position, size, and shape of the interlaced images printed on the substrate in that a single pattern forming device can accommodate a change thereto.

The present invention has been described in terms of various embodiments. It is recognized that equivalents, alternatives, and modifications, aside from those expressly stated, are possible and within the scope of the appending claims.

What is claimed is:

1. A method of creating a selectively-formed lenticular image, the method comprising:
providing a substrate having a printed interlaced image portion thereon;
providing a coating applicator having a selectively located coating transfer area that substantially conforms to the interlaced image portion on the substrate;
applying to the interlaced image portion on the substrate, using the selectively located coating transfer area, a coating layer that substantially conforms to the interlaced image portion to form a coated interlaced image;
curing the coated interlaced image to a lenticular pattern forming curing level to create a cured coated interlaced image; and
forming a lenticular pattern in the cured coated interlaced image to create a selectively formed lenticular image.

2. The method of claim 1 further comprising curing the selectively formed lenticular image.

3. The method of claim 1 further comprising printing an interlaced image to the substrate to create the interlaced image portion.

4. The method of claim 3 wherein the printing is accomplished using at least one of: sheet-fed, web, roto-gravure, lithographic, flexo-graphic, letter-press, laser, ink-jet, screen and digital techniques.

5. The method of claim 1 wherein the coating applicator includes a cylinder and a plate secured to the cylinder.

6. The method of claim 1 wherein the coating applicator includes a flexographic plate.

7. The method of claim 1 wherein the coating applicator includes a gravure plate.

8. The method of claim 1 wherein coating applicator includes a slot die.

9. The method of claim 1 wherein the applying step includes applying at least one of a liquid resin, a varnish, and a liquid polymer.

10. The method claim 1 wherein the substrate includes paper.

11. The method of claim 1 wherein the substrate includes at least one of: plastic, synthetic paper, metal, glass, and wood.

12. The method of claim 1 wherein the substrate is in sheet format.

13. The method of claim 1 wherein the substrate is in web format.

14. The method claim 1 wherein the selectively formed lenticular image covers a fractional portion of the substrate.

15. The method of claim 1 wherein the curing is an ultraviolet (UV) curing.

16. The method of claim 1 wherein the curing is an electron beam (EB) curing.

17. The method of claim 1 wherein the forming includes embossing.

18. The method of claim 1 wherein the applying includes at least one of: lithographic, offset lithographic, flexographic, electrostatic, and gravure.

19. The method of claim 1 wherein the selectively located coating transfer area on the coating applicator is one of chemically reactive and electrically charged.

20. The method of claim 1 wherein the curing is a heat set curing.

21. The method of claim 20 wherein the selectively located coating transfer area on the coating applicator includes at least one of a raised area and a recessed area for transferring the coating layer at least one of directly and indirectly.

22. The method of claim 1 wherein the forming occurs exclusively in the cured coated interlaced image.

23. The method of claim 1 wherein the substrate includes printed information in addition to the interlaced image.

24. The method of claim 23 wherein the printed information includes at least one of: a non-interlaced image, text, a graphic and a picture.

25. The method of claim 1 wherein the substrate includes blank or nonprinted areas.

26. The method of claim 1 wherein the coating layer includes a lenticular coating.

27. The method of claim 1 wherein the coating layer includes a liquid polymer or resin.

28. The method of claim 1 wherein the curing is continued until the coating layer reaches a predetermined curing level prior to the forming.

29. The method of claim 1 wherein the applying and the curing are repeated to achieve a desired coating thickness.

30. The method of claim 1 wherein the forming is accomplished using a lenticular pattern forming device.

31. The method of claim 30 wherein the lenticular pattern forming device is an engraved cylinder.

32. The method of claim 30 further including contacting the cured coated interlaced image with the lenticular pattern-forming device and temperature controlling the lenticular pattern forming device to facilitate release of the cured coated interlaced image from the lenticular pattern forming device.

33. The method of claim 1 wherein the substrate includes a plurality of interlaced image portions.

34. The method of claim 1 wherein the selectively formed lenticular image comprises a lenticular lens formed from the coating layer positioned over the interlaced image portion.

35. The method of claim 34 wherein the lenticular lens has a gauge thickness and wherein the gauge thickness is less than about 10 mils.

36. The method of claim 35 wherein the lenticular pattern-forming device embosses the lenticular pattern to a depth of from about five percent (5%) to about thirty percent (30%) of the gauge thickness of the lenticular lens.

37. The method of claim 1 wherein forming is accomplished by a lenticular pattern-forming device having a groove pattern that covers substantially the entire device arcuate surface area.

38. The method of claim 37 wherein the lenticular pattern of the pattern forming device includes a plurality of grooves that run one of parallel to and concentric with a central longitudinal axis of the lenticular pattern-forming device.

39. The method of claim 1 wherein the selectively formed lenticular image includes a lenticular lens having a pitch of at least 150 lenticules per inch.

40. The method of claim 1 further comprising creating a plate having a selectively-located coating transfer area that conforms to the interlaced image portion on the substrate.

41. The method claims 40 wherein the selectively-located coating transfer area is a raised area.

42. The method of claim 40 wherein the selectively-located coating transfer area is one of a flush, recessed and charged area.

43. A selectively formed lenticular image made by the method of claim 1.

44. A method of creating a selectively-formed lenticular image, the method comprising:
providing a substrate having a printed interlaced image portion thereon;
providing a coating applicator having a selectively-located coating transfer area that substantially conforms to the interlaced image portion on the substrate;
applying to the interlaced image portion on the substrate, using the selectively-located coating transfer area, a coating layer that substantially conforms to the interlaced image portion to form an intermediate coated interlaced image;
curing the intermediate coated interlaced image to coating layer application curing level to create an intermediate cured coated interlaced image;
applying to the intermediate cured coated interlaced image portion, using the selectively-located coating transfer area, a second coating layer that also substantially conforms to the interlaced image portion to form a coated interlaced image;
curing the coated interlaced image to lenticular pattern forming curing level to create a cured coated interlaced image; and
forming a lenticular pattern in the cured coated interlaced image to create a selectively formed lenticular image.

45. The method of claim 44 further comprising curing the selectively formed lenticular image.

46. The method of claim 44 further comprising printing an interlaced image to the substrate to create the interlaced image portion.

47. The method of claim 44 wherein applying the coating layer includes applying a lenticular lens material.

48. The method claim 44 wherein the selectively formed lenticular image covers a fractional portion of the substrate.

49. The method of claim 44 wherein the substrate includes a plurality of interlaced image portions.

50. The method of claim 44 further comprising creating a plate having a selectively-located coating transfer area that conforms to the interlaced image portion on the substrate.

51. A selectively formed lenticular image made by the method of claim 44.

52. A method of creating a selectively-formed lenticular image, the method comprising:
providing a substrate having a printed interlaced image portion thereon;
providing first and second coating applicators each having a selectively-located coating transfer area that substantially conforms to the interlaced image portion on the substrate;
applying to the interlaced image portion on the substrate, using the first selectively-located coating transfer area, a coating layer that substantially conforms to the interlaced image portion to form an intermediate coated interlaced image;
curing the intermediate coated interlaced image to a coating layer application curing level to create an intermediate cured coated interlaced image;
applying to the intermediate cured coated interlaced image portion, using the second selectively-located coating transfer area, a second coating layer that also substantially conforms to the interlaced image portion to form a coated interlaced image;
curing the coated interlaced image to a lenticular pattern forming curing level to create a cured coated interlaced image; and
forming a lenticular pattern in the cured coated interlaced image to create a selectively formed lenticular image.

53. The method of claim 52 further comprising curing the selectively formed lenticular image.

54. The method of claim 52 further comprising printing an interlaced image to the substrate to create an interlaced image portion.

55. The method of claim 52 wherein applying the coating layer includes applying a liquid lenticular lens material which comprises at least one of a varnish, plastic and a resin.

56. The method of claim 52 wherein the applying includes using at least one of a flush, recessed and charged area on the coating applicator to transfer the coating layer.

57. The method of claim 52 further comprising creating a plate having a selectively-located coating transfer area that conforms to the interlaced image portion on the substrate.

58. A selectively formed lenticular image made by the method of claim 52.

59. A method of creating a selectively-formed lenticular image, the method comprising:
providing a substrate having a printed interlaced image portion thereon;
providing a plurality of coating applicators, each of the applicators having a selectively-located coating transfer area that substantially conforms to the interlaced image portion on the substrate;
applying to the interlaced image portion on the substrate, using one of the selectively-located coating transfer areas, a coating layer that substantially conforms to the interlaced image portion to form an intermediate coated interlaced image;
curing the intermediate coated interlaced image to coating layer application curing level to create an intermediate cured coated interlaced image;
applying to the intermediate cured coated interlaced image portion, using one of the selectively-located coating transfer areas, at least one additional coating layer that also substantially conforms to the interlaced image portion to form a coated interlaced image;
curing the coated interlaced image to a lenticular pattern forming curing level create a cured coated interlaced image; and
forming a lenticular pattern in the cured coated interlaced image to create a selectively formed lenticular image.

60. The method of claim 59 further comprising curing the selectively formed lenticular image.

61. The method of claim 59 further comprising printing an interlaced image to the substrate to create an interlaced image portion.

62. The method of claim 59 wherein applying the coating layer includes applying a liquid lenticular lens material which comprises at least one of a varnish, thermoplastic and a resin.

63. The method of claim 59 wherein the applying includes using at least one of a flush, recessed, chemically repelling, and charged area on the coating applicator to transfer the coating layer.

64. The method of claim 59 further comprising creating a plate having a selectively-located coating transfer area that conforms to the interlaced image portion on the substrate.

65. A selectively formed lenticular image made by the method of claim 59.

66. A method of creating a plurality of selectively-formed lenticular images, the method comprising:
providing a substrate having a plurality of printed interlaced image portions thereon;
providing a coating applicator having a plurality of selectively-located coating transfer areas that substantially conform to the interlaced image portions on the substrate;
applying to the interlaced image portions on the substrate, using the selectively-located coating transfer areas, a coating layer that substantially conforms to the interlaced image portions to form a plurality of coated interlaced images;
curing the coated interlaced images to a lenticular pattern forming curing level to create a plurality of cured coated interlaced images; and
forming a lenticular pattern in each of the cured coated interlaced images to create a plurality of selectively formed lenticular images.

67. The method of claim 66 further comprising curing the selectively formed lenticular image.

68. The method of claim 66 further comprising printing an interlaced image to the substrate to create an interlaced image portion.

69. The method of claim 66 wherein applying the coating layer includes applying a liquid lenticular lens material which comprises at least one of a varnish, thermoplastic and a resin.

70. The method of claim 66 further comprising creating a plate having a selectively-located coating transfer area that conforms to the interlaced image portion on the substrate.

71. A selectively formed lenticular image made by the method of claim 66.

72. A system for making a selectively-formed lenticular image comprising:
means for applying, to an interlaced image portion printed on a substrate, a coating layer that conforms to the interlaced image portion to form a coated interlaced image, the means comprising a selectively-located coating transfer area that substantially conforms to the interlaced image portion on the substrate;
means for curing the coated interlaced image to a lenticular pattern forming curing level to create a cured coated interlaced image; and
means for forming a lenticular pattern in the cured coated interlaced image to create a selectively formed lenticular image.

73. The system of claim 72 further comprising means for curing the selectively formed lenticular image.

74. The system of claim 72 wherein the means for applying applies a coating layer to a plurality of interlaced image portions.

75. The system of claim 72 wherein the means for applying includes a coating applicator that includes a cylinder and a plate secured to the cylinder.

76. The system of claim 72 wherein the coating applicator includes a flexographic plate.

77. The system of claim 72 wherein the means for applying includes means for applying a liquid lenticular lens material which comprises at least one of a varnish, plastic and a resin.

78. The system of claim 72 wherein the substrate includes at least one of paper, plastic, synthetic paper, metal, glass and wood and wherein the substrate is in one of sheet and web format.

79. The system of claim 72 wherein the means for forming includes embossing means.

80. The system of claim 72 wherein the means for applying includes at least one of a flush, recessed and charged area.

81. The system of claim 72 wherein the means for forming includes a lenticular pattern forming device.

82. The system of claim 81 wherein the means for forming forms the lenticular pattern to a depth of from about five percent (5%) to about thirty percent (30%) of the gauge thickness of the lenticular lens.

83. The system of claim 81 wherein means for forming includes a lenticular pattern-forming device having a groove pattern that covers substantially the entire device arcuate surface area.

84. The system of claim 81 wherein means for forming includes a lenticular pattern-forming device having a platen with a recessed area and a die positioned within the recessed area.

85. The system of claim 84 wherein the die fills substantially all of the recessed area.

86. The system of claim 84 wherein lenticular pattern forming device comprises a plurality of dies positioned within the recessed area.

87. The system of claim 81 wherein the means for applying includes a heatable platen for transferring a membrane portion from a foil membrane to the interlaced image portion printed on the substrate.
